(19) United States
(12) Patent Application Publication
(10) Pub. No.: US 2008/0041228 A1
(43) Pub. Date: Feb. 21, 2008

(54) Method of dehydration of gases with liquid desiccants

(76) Inventor: Brian Howard Seibert, Stony Plain (CA)

Correspondence Address: DAVIS BUJOLD & Daniels, P.L.L.C., 112 PLEASANT STREET, CONCORD, NH, 03301, US

(21) Appl. No.: 11/506,400

(22) Filed: Aug. 18, 2006

(51) Int. Cl. B01D 53/14

(52) U.S. Cl. 95/166

(57) ABSTRACT

An improved method of drying natural or other gases to extremely low water dewpoints via countercurrent contact with very pure hygroscopic liquid desiccant which is regenerated by heating and reboiling in a distillation stripping column. Preferably, the liquid desiccant is further regenerated in an azeotropic distillation stripping column using a condensable hygroscopic vapor as a stripping and azeotroping medium.

### FIELD

The present application relates to a method of dehydration of gases in which liquid desiccants are used, for the purpose of drying or sweetening natural gas or other gases.

### BACKGROUND

Liquid desiccants such as mono-, di- and tri- ethylene glycols were first employed in the 1950's to dry natural gases in order to reduce corrosion of pipelines and to prevent the formation of gas hydrates that would block pipelines. Regeneration of the liquid desiccants was accomplished by heating the glycol in a reboiler and purifying same in a distillation column to a glycol purity of up to 98.5% which allowed the gas to be dried to a water content of about 10 lbs water per million standard cubic feet of gas. The introduction of sparging natural gas into the reboiler in the late 1950's and early 1960's allowed regeneration systems to attain a glycol purity of 99.4% that allowed the gas to be dried to a water content of about 7 lbs water per MMSCF.

In 1963 Willy Stahl invented the natural gas stripping column (U.S. Pat. No. 3,105,748) for Parkersburg Rig & Reel, and Black, Sivals and Bryson Inc. liked the idea so much they bought the company. The introduction of a gas stripping column for polishing the glycol after reboiling allowed regeneration systems to attain a glycol purity of 99.9% for a resultant gas water content of under 4 lbs per MMSCF which was a specification employed in areas with colder climates where hydrate formation and water condensation in pipelines was more problematic. But the problem with the Stahl column remains that significant quantities of stripping gas are lost to atmosphere with the reboiled distillation column overheads steam.

In 1967 John Arnold, Roscoe Pearce and Herman Scholten of The Dow Chemical Company invented a process of regenerating liquid desiccant by azeotropic distillation (U.S. Pat. No. 3,349,544) whereby a condensable hydrocarbon vapor was introduced into the glycol reboiler in order to provide a purer glycol through azeotropic distillation in the reboiler still column. Still column overheads were condensed and liquid water was rejected while condensed stripping agent was reintroduced to the reboiler. Although the patent dealt with a glycol amine drying and sweetening agent and water dewpoint depressions were not extreme, further patents by Dow exhibited greater gas drying potential. In 1977 Allan Fowler and John Protz of the Dow Chemical Company invented an azeotropic regeneration process (U.S. Pat. No. 4,005,997) that introduced a Stahl-type stripping column downstream of the normal azeotropic glycol process and condensable hydrocarbon vapor was introduced first into this column for moisture stripping then into the distillation column for primary azeotropic distillation. Again, the still column overheads were condensed, the liquid water was rejected and the condensed hydrocarbon liquid was pumped, vaporized and reintroduced to the stripping column. This process allowed regeneration systems to attain a glycol purity of 99.99% for a resultant gas water content in the low parts per million.

In 1985 OPC Engineering of Houston acquired the rights to the Dow technology and in 1997 Robert Smith of OPC patented a process using solid desiccant to remove dissolved moisture from the condensed hydrocarbon stripping agent prior to reintroduction to the stripping column of the glycol reboiler (U.S. Pat. No. 5,643,421). Glycol purities of 99.999% with a resultant gas water content as low as 0.1 parts per million became attainable. This process has been used successfully for gas drying upstream of cryogenic turbo-expander gas plants, but again the total still column overheads are condensed, involving aerial coolers, separators, pumps and drying systems.

### SUMMARY

There is provided a method of dehydration of gases with liquid desiccant. A first step involves contacting wet gas with a very pure hygroscopic liquid desiccant in order to dry the gas and recirculating the wet liquid desiccant for regeneration and reuse. A second step involves introducing the wet liquid desiccant to a regeneration system distillation column for primary regeneration to produce lean liquid desiccant. A third step involves reboiling the lean liquid desiccant to maintain regeneration temperatures. A fourth step involves introducing the lean liquid desiccant to a regeneration system stripping column and contacting it with a stripping medium to vaporize further moisture from the lean liquid desiccant. A fifth step involves separating the stripping medium for reuse, condensed steam in the form of water for disposal, and the very lean liquid desiccant for recirculation and reuse.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic drawing of a natural gas dehydration unit employing a liquid desiccant regeneration system.

### DETAILED DESCRIPTION

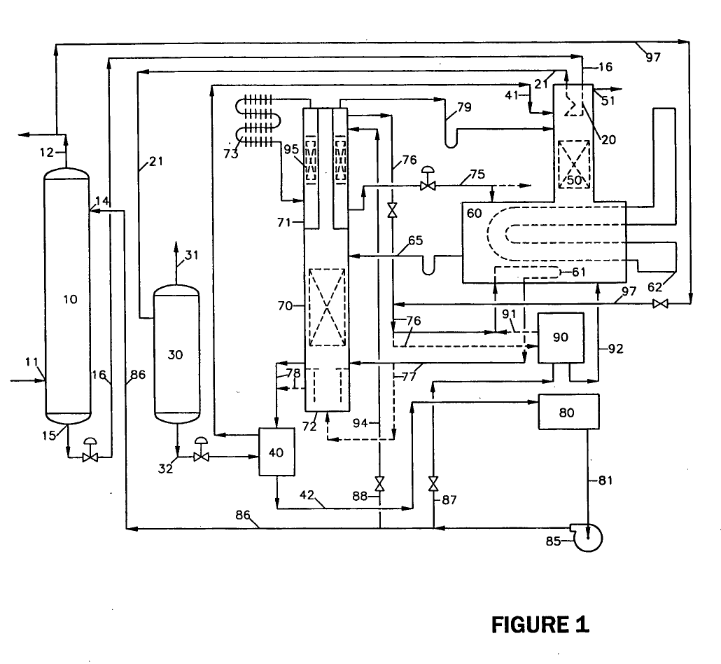

The preferred method will now be described with reference to FIG. 1.

The drying of natural or other gases takes place in the gas/liquid desiccant countercurrent contactor 10 with the relatively high pressure wet gas entering the lower side of the contactor at inlet 11 and the dried gas exiting the top of the contactor at outlet 12. Lean or dry hygroscopic liquid desiccant enters the upper side of the contactor at inlet 14 and rich or wet liquid desiccant leaves the bottom of the contactor at outlet 15.

Rich liquid desiccant is level controlled from the contactor through line 16 to the still column condensing coil 20, where the cooling effect of the relatively cold liquid desiccant condenses reflux water out of the distillation column 50 overhead steam to minimize overheads liquid desiccant vaporization losses, and the now warm rich liquid desiccant then flows through line 21 to the liquid desiccant flash separator 30 where absorbed soluble gases are flashed off and directed from the regeneration system through line 31.

Rich liquid desiccant is level controlled from the liquid desiccant flash separator 30 through line 32 to the rich/lean liquid desiccant heat exchanger 40, by which rich liquid desiccant is heated and lean liquid desiccant is cooled, and the now hot rich liquid desiccant is directed through line 41 to the top of the liquid desiccant distillation (still) column 50, for primary regeneration.

Rich liquid desiccant flows down the still column 50, which may be equipped with a packed, trayed or otherwise devised countercurrent contacting section, and counter-currently contacts lean liquid desiccant and water vapors and the heat from said contact strips the water from the downflowing desiccant. The vaporized water rises up the still column and is directed through line 51 to atmosphere or to a thermal oxidizer or to an overheads condenser for further processing. In the latter case, the condensed steam and any condensed and non-condensed process vapors may be directed to an overheads separator from which the water is directed to a disposal tank, the process liquid, hydrocarbon or otherwise, to a storage tank for reuse as stripping agent or commercial sales, and the non-condensable process gases, hydrocarbon or otherwise, may be directed to a sweetener, an incinerator or both or to atmosphere as process and environmental conditions warrant.

The now lean liquid desiccant exits the bottom of the still column 50 and enters the liquid desiccant reboiler 60, by which heat is added to the process to develop the desiccant vapours required in the still column reaction, and the lean desiccant is liquid seal or level controlled from the reboiler 60 through line 65 to the desiccant stripping column 70. The desiccant stripping column 70 may be external to the reboiler 60 but is preferably mounted vertically through the reboiler 60 so that the stripping column 70 is immersed in hot liquid desiccant to make up for heat lost in the process of vaporizing further water with hot stripping vapor in the stripping column 70. Heat may be added to the liquid desiccant reboiler 60 via a direct-fueled firetube 62, an electric heating coil, heat transfer medium or by other such devices.

The lean liquid desiccant enters the top of the liquid desiccant stripping column 70, which may be equipped with one or more packed, trayed or otherwise devised countercurrent contacting sections, and flows down, counter-currently contacting rising hygroscopic condensable gaseous stripping vapors which absorb most of the remaining traces of water from the lean liquid desiccant, which then exits the bottom of the stripper. The rising moisture laden condensable vapors flow up an anulus of the stripping medium/water separator 71, and are directed to an overheads condensing coil 73, where the condensable stripping medium and absorbed water vapor are condensed into two immiscible liquids. The condensed liquids enter midpoint into the side of the stripping medium/water separator 71, and the water gravity settles to the bottom of the separator 71 where it is level controlled back to the reboiler 60 or to a disposal tank through line 75, and the liquid stripping medium rises to the top of the separator 71 where it accumulates and is gravity fed, or pumped, at a set stripping flow rate through line 76 to the reboiler stripping medium vaporizing coil 61 prior to reintroduction through line 77 to the stripping column 70. Excess stripping medium may be drawn off or consumed medium may be made up, from a stripping medium storage tank (not shown).

Lean liquid desiccant then flows from the stripping column 70 through line 78 to the lean/rich liquid desiccant exchanger 40, by which it is cooled, and on through line 42 to the liquid desiccant accumulator 80. Lean liquid desiccant then flows from the accumulator 80 through line 81 to the liquid desiccant recirculation pump 85, by which it is reinjected via line 86 to the top of the gas/liquid desiccant countercurrent contactor 10, thus completing a full regeneration circuit.

In a further embodiment a gas lift recirculating stripping chamber 72 may be added to the bottom of the liquid desiccant stripping column 70. Lean liquid desiccant then flows from the bottom of the stripping column 70 into the top of the stripping chamber 72 where the lean desiccant accumulates and recirculates in contact with the gas lifting action of the stripping vapors that are introduced into the bottom of the stripping chamber 72 through alternate line 77 in lieu of into the stripping column 70. The very lean desiccant exits the top of the stripping chamber 72 through alternate line 78 and continues on to the lean/rich desiccant exchanger as previously described and the stripping vapor exits the top of the stripping chamber 72 and enters the bottom of the stripping column 70.

In a further embodiment, a liquid/liquid packed contactor section 95 may be added into the stripping medium/water separator 71, whereby liquid stripping medium gravity flows upward through the packing of contactor 95 and a slipstream of lean liquid desiccant flows from the desiccant recirculating pump 85 discharge through line 88 to the top of the packed contactor section 95and the lean liquid desiccant absorbs any soluble water that may be present in the liquid stripping medium, which then continues its circuit through line 76 to the stripping medium vaporizing coil 61 as previously described. The spent liquid desiccant is then returned through line 75 to the liquid desiccant reboiler 60 for regeneration.

In a further embodiment, a non-condensable stripping vapor may be utilized in lieu of condensable stripping vapor by closing the condensable stripping vapor control valve in line 76 and by opening the non-condensable stripping vapor control valve in line 97. This allows a slipstream of dry process gas to enter the stripping circuit in countercurrent contact with the lean downflowing desiccant in stripping column 70. The rising hygroscopic non-condensable gaseous stripping vapors absorb most of the remaining traces of water from the lean liquid desiccant prior to flowing up the annulus of the stripping medium/water separator 71 and on to an overhead condensing coil 73 and into the separator where any condensed water may be separated. The non-condensable stripping vapor flows from the separator 71 through line 79 and its liquid seal into still column 50 and off to atmosphere with the overheads steam through line 51.

The present method provides an improved and simplified method of azeotropic stripping and distillation of gas drying and sweetening liquid desiccants. The improved method still utilizes a reboiler and distillation column to remove the bulk of liquid water absorbed by the liquid desiccant, but it employs a liquid or valve seal between the reboiler and a polishing stripping column in which a condensable hygroscopic vapor counter-currently contacts the semi-lean descending liquid desiccant to remove the last traces of water prior to recirculation of the now very lean desiccant to the countercurrent gas contactor. The water laden hygroscopic stripping vapor rises up an internal conduit of a separation chamber mounted above the stripping column to a condensing coil where the hygroscopic stripping medium and water vapors are liquefied and introduced into said upper separation chamber, where the two now immissible liquids gravity separate. The water settles to the bottom of the chamber and is level controlled and gravity fed to a water disposal tank or back into the reboiler as the process warrants, while the stripping medium rises to the top of the chamber where it is gravity fed to a vaporizing coil in the reboiler for vaporization and reintroduction to the stripping column. This thermally driven percolation system eliminates pumps and simplifies other systems required in the prior arts, although pumps may still be employed if of benefit to the process.

The present method regenerates a hygroscopic liquid desiccant to a very low moisture content using a condensable hygroscopic vapor in a recirculating stripping vapor loop, allowing for the attainment of extremely low water contents of natural or other gases without the utilization of non-condensable stripping gas, which is typically vented to atmosphere, although this liquid desiccant regeneration system may be designed to operate either with condensable hygroscopic vapor or non-condensable stripping gas in the stripping column as operating, process and environmental circumstances warrant. Besides eliminating costly stripping gas losses, the use of a condensable hygroscopic stripping vapor in lieu of a non-condensable stripping gas allows for the improved recovery of desiccant absorbed hydrocarbons such as propane, butane and pentane plus liquids and, in particular, condensable BTEX hydrocarbons such as benzene, toluene, ethyl benzene and xylene. These vaporized liquids and gases are difficult to condense in the presence of methane stripping gas, so the utilization of a condensable hygroscopic stripping medium becomes imperative when recovering desiccant absorbed liquid hydrocarbon products. This is accomplished by condensing the overheads of the distillation column, consisting mainly of steam but also quantities of condensable hydrocarbons and, in some cases, non-condensable gases and separating same in a three phase separation vessel into water for disposal, hydrocarbon liquids for further processing or sale and non-condensable gases, if present, for thermal oxidation or venting.

The present method regenerates a hygroscopic liquid desiccant to a very low moisture content by employing very high condensable hygroscopic vapor stripping flow rates without the accompanying high liquid desiccant losses in the effluent water by reintroducing the rejected stripping column water back to the reboiler for further distillation. This recovery of liquid desiccant within the water stripping circuit allows for the utilization of low vapour pressure desiccants such as monoethylene glycol at extremely high purities for the attainment of high water dewpoint depression of natural or other gases while minimizing desiccant absorption of unwanted gases such as BTEX, Hydrogen Sulphide and other deleterious components that might be present in the gas stream being treated. Conversely, this same inherent recovery of liquid dessicant losses allows for the full or partial use of sweetening agents such as MEA, DEA or MDEA in conjunction with or as a hygroscopic liquid desiccant to accomplish both gas drying and sweetening simultaneously.

The present method introduces a liquid dominant gas lift recirculating stripping chamber below the vapor dominant stripping column to increase the number of stages of contact the condensable hygroscopic vapor attains in countercurrent contact with the liquid desiccant for any given height restriction. This is accomplished by introducing the stripping vapor into the central cylinder of a multi-cylindered vessel, concentrically arranged, and filled with liquid desiccant so that the dispersed vapor causes the desiccant in the center chamber to rise and overflow to the outer chamber where it descends and returns to the inner chamber to rise once again for another stage of contact with the rising stripping vapor stream. The liquid desiccant enters the center chamber from the vapor dominant stripping column above it and is drawn off from the top of the outer annulus at its normal rate of circulation, while the stripping vapor enters the central chamber at the bottom and exits out the top of the central chamber into the vapor dominant stripping column above it at a rate limited only by the size of the stripping vapor condensing coil at the top of the stripping vapor circuit and by the size of the vaporization coil at the bottom of the circuit.

The present method introduces a slipstream of the regenerated liquid desiccant into contact with the condensed hygroscopic stripping medium either directly in a static mixer or a countercurrent contactor followed by gravity separation, or indirectly through a liquid/liquid membrane contactor in order to remove any soluble water remaining in the stripping agent prior to revaporization. The wetted glycol slipstream is then returned to the reboiler. This final dehydrating device allows for gas water dewpoint depressions suitable for further cryogenic gas treating.

The present method is capable of operating the regeneration and stripping systems below, at or above atmospheric pressure should process conditions so warrant. Because the primary reboiling system is separated from the final stripping circuit by a valve or liquid seal, the reboiler may be operated at higher or lower relative pressures than the stripping column to suit specific process requirements.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope defined in the Claims.

What is claimed is:

1. A method of dehydration of gases with liquid desiccant; comprising the steps of:
contacting wet gas with a very pure hygroscopic liquid desiccant in order to dry the gas and recirculating the wet liquid desiccant for regeneration and reuse;
introducing the wet liquid desiccant to a regeneration system distillation column for primary regeneration to produce lean liquid desiccant;
reboiling the lean liquid desiccant to maintain regeneration temperatures;
introducing the lean liquid desiccant to a regeneration system stripping column and contacting it with a stripping medium to remove further moisture from the lean liquid desiccant; and
separating the stripping medium for reuse, condensed steam in the form of water for disposal, and the very lean liquid desiccant for recirculation and reuse.

2. The method as defined in claim 1, including a step of further treating the very lean liquid desiccant in a gas lift recirculating stripping chamber.

3. The method as defined in claim 1, the hygroscopic liquid desiccant being selected from glycols, amines or mixtures of glycols and amines.

4. The method as defined in claim 1, the stripping medium being a condensable hygroscopic stripping vapor and a step being taken of condensing the hygroscopic stripping medium and steam overheads of the stripping column to form two immissible liquids prior to the separating step.

5. The method as defined in claim 4, including a step of further drying the stripping medium in one of a liquid/liquid membrane contactor, static mixer, or countercurrent contactor.

6. The method as defined in claim 4, the condensable hygroscopic stripping medium being selected from octane, iso-octane, alkanes, aliphatic hydrocarbons, aromatic hydrocarbons, natural gasoline, refined gasoline or naptha.

7. The method as defined in claim 1, the stripping medium being a non-condensable stripping gas.

8. The method as defined in claim 1, the reboiler being separated from the stripping column by one of a valve or a liquid seal, such that the reboiler may be operated at higher or lower relative pressures than the stripping column.

9. The method as defined in claim 1, the wet gas being any gaseous vapor requiring drying or sweetening, selected from natural gas, refinery gas, synthesis gas, hydrogen, carbon dioxide or oil production solution gas.
